(19) United States
(12) Patent Application Publication
(10) Pub. No.: US 2025/0384273 A1
(43) Pub. Date: Dec. 18, 2025

(54) EFFICIENT SELF-SPECULATIVE DECODING ARCHITECTURE FOR INCREASING LLM INFERENCE THROUGHPUT

(71) Applicant: SAMSUNG ELECTRONICS CO., LTD., Suwon-si (KR)

(72) Inventors: James SMITH, Decatur, GA (US); Yen-Chang HSU, Fremont, CA (US); Chi-Heng LIN, Mountain View, CA (US); Shikhar TULI, Sunnyvale, CA (US); Gulam Mohammed Haras JEELANI, Mountain View, CA (US); Yilin SHEN, Mountain View, CA (US); Hongxia JIN, San Jose, CA (US)

(73) Assignee: SAMSUNG ELECTRONICS CO., LTD., Suwon-si (KR)

(21) Appl. No.: 18/984,046

(22) Filed: Dec. 17, 2024

Related U.S. Application Data
(60) Provisional application No. 63/660,925, filed on Jun. 17, 2024.

(51) Int. Cl. G06N 3/082; G06N 3/0475

(52) U.S. Cl. CPC G06N 3/082; G06N 3/0475

(57) ABSTRACT

A method of generating a token for a language model includes obtaining a language model comprising one or more transformer blocks, training the language model based on one or more parameters, identifying a first parameter, from among the one or more parameters, to compress or remove from the language model, finetuning the language model based on the first parameter being compressed or removed, and providing the finetuned language model to an electronic device.

### CROSS-REFERENCE TO RELATED APPLICATION

This application claims priority to U.S. provisional application No. 63/660,925filed on Jun. 17, 2024, the entire contents of which are incorporated herein by reference.

### BACKGROUND

### 1. Field

This disclosure relates to a method and apparatus for efficiently decoding a model to increase throughput.

### 2. Description of Related Art

Large language models (LLMs) may be used in the development of artificial intelligence (AI) assistants. This has led to the adoption of LLMs as chatbots in diverse applications, e.g., healthcare, e-commerce, education, etc. However, traditional language models operate autoregressively, i.e., they only predict one token at a time. Rapid explosion in model sizes has resulted in high inference times. This has made efficient deployment of conversational AI agents on resource-constrained edge platforms a challenging proposition, as even compact language models result in significant latencies.

### SUMMARY

According to an aspect of the disclosure, method of generating a token for a language model includes: obtaining a language model comprising one or more transformer blocks; training the language model based on one or more parameters; identifying a first parameter, from among the one or more parameters, to compress or remove from the language model; finetuning the language model based on the first parameter being compressed or removed; and providing the finetuned model to an electronic device.

According to an aspect of the of disclosure, a server device includes: a memory storing instructions; and at least one processor, wherein the instructions, when executed by the at least one processor, cause the server device to: obtain a language model comprising one or more transformer blocks; train the language model based on one or more parameters; identify a first parameter, from among the one or more parameters, to compress or remove from the language model; finetune the language model based on the first parameter being compressed or removed; and providing the finetuned model to an electronic device.

According to an aspect of the disclosure, a non-transitory computer-readable recording medium configured to store instructions for generating a language model, which, when executed by at least one processor of an electronic device, cause the at least one processor to perform a method including: obtaining a language model comprising one or more transformer blocks; training the language model based on one or more parameters; identifying a first parameter, from among the one or more parameters, to compress or remove from the language model; finetuning the language model based on the first parameter being compressed or removed; and providing the finetuned model to another electronic device.

### BRIEF DESCRIPTION OF THE DRAWINGS

Features and/or aspects of the disclosed subject matter will be more apparent from the following detailed description and the accompanying drawings in which:

FIG. 1 is a block diagram of example components of one or more devices, in accordance with one or more embodiments of the disclosure;

FIG. 2 illustrates an example of speculative decoding, according to an embodiment;

FIG. 3 illustrates an example of compressing a neural network model, according to an embodiment;

FIGS. 4A and 4B illustrate examples of output drafting and output verification, according to one or more embodiments;

FIGS. 5A and 5B illustrate pruning and extending, according to one or more embodiments;

FIG. 6 illustrates an example of skipping model blocks, according to an embodiment;

FIG. 7 illustrates an example of selecting replacement blocks, according to an embodiment;

FIG. 8 illustrates an example of normalizing features for a transformer block, according to an embodiment;

FIG. 9 is an example of extending a neural network model by repeating transformer blocks, according to an embodiment;

FIG. 10 is an example method of generating a neural network model, according to an embodiment;

FIG. 11 is an example method of deploying a language model on a mobile device, according to an embodiment;

FIG. 12 is an example method of generating a neural network model, according to an embodiment; and

FIG. 13 is an example method of generating a neural network model, according to an embodiment.

### DETAILED DESCRIPTION

The following detailed description of example embodiments refers to the accompanying drawings. The same reference numbers in different drawings may identify the same or similar elements.

The disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware or firmware. The actual specialized control hardware used to implement these systems and/or methods is not limiting of the implementations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

In this disclosure, a new model speedup method is provided which rapidly generates tokens using a discovered path through the LLM which selectively skips model layers based on an importance score. These tokens are verified in parallel by the full LLM, resulting in a significant speedup in token generation (i.e., throughput), without requiring any additional parameters, heads, or output degradation. Furthermore, a method is provided that is parameter efficient in addition to being throughput efficient. For example, skipped model blocks may be pruned and replaced with a low-parameter replacement strategy which directly utilizes the existing weights within the model. That is layers (or, blocks) in the model which do not contribute greatly to the LLM's final output may be skipped. Thus, the model is sped up by skipping these blocks, and then the outputs are verified in parallel to retain the main model's (e.g., large model) full capabilities. Significant additional parameters are not required according to one or more embodiments.

One or more embodiments provide for model speedup without requiring additional training, while fully retaining model output generations. One or more embodiments provide for a parameter-efficient model that produces a compressed model with high accuracy and minimal training.

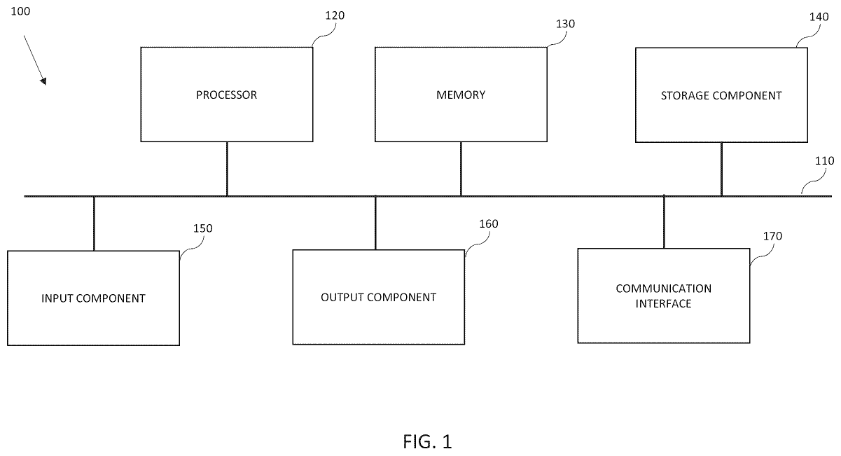

FIG. 1 is a block diagram of example components of one or more devices, in accordance with one or more embodiments of the disclosure. A device 100 may be any suitable device such as a server device, smartphone, tablet, wearable device (e.g., smartwatch, earbuds, hearing aid), smart home appliance (e.g., refrigerator, vacuum cleaner), TV or wall panel. As shown in FIG. 1, the device 100 may include a bus 110, a processor 120, a memory 130, a storage component 140, an input component 150, an output component 160, and a communication interface 170.

The bus 110 includes a component that permits communication among the components of the device 100. The processor 120 is implemented in hardware, firmware, or a combination of hardware and software. The processor 120 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 120 includes one or more processors capable of being programmed to perform a function. The memory 130 includes a random access memory (RAM), a read only memory (ROM), and/or another type of dynamic or static storage device (e.g. a flash memory, a magnetic memory, and/or an optical memory) that stores information and/or instructions for use by the processor 120.

The storage component 140 stores information and/or software related to the operation and use of the device 100. For example, the storage component 140 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 150 includes a component that permits the device 100 to receive information, such as via user input (e.g. a touch screen display, a keyboard, a keypad, a mouse, a button, a switch, and/or a microphone). Additionally, or alternatively, the input component 150 may include a sensor for sensing information (e.g. a global positioning system (GPS) component, an accelerometer, a gyroscope, and/or an actuator). The output component 160 includes a component that provides output information from the device 100 (e.g. a display, a speaker, and/or one or more light-emitting diodes (LEDs)).

The communication interface 170 includes a transceiver-like component (e.g., a transceiver and/or a separate receiver and transmitter) that enables the device 100 to communicate with other devices, such as via a wired connection, a wireless connection, or a combination of wired and wireless connections. The communication interface 170 may permit the device 100 to receive information from another device and/or provide information to another device. For example, the communication interface 170 may include an Ethernet interface, an optical interface, a coaxial interface, an infrared interface, a radio frequency (RF) interface, a universal serial bus (USB) interface, a Wi-Fi interface, a cellular network interface, or the like.

The device 100 may perform one or more processes described herein. The device 100 may perform these processes in response to the processor 120 executing software instructions stored by a non-transitory computer-readable medium, such as the memory 130 and/or the storage component 140. A computer-readable medium is defined herein as a non-transitory memory device. A memory device includes memory space within a single physical storage device or memory space spread across multiple physical storage devices.

Software instructions may be read into the memory 130 and/or the storage component 140 from another computer-readable medium or from another device via the communication interface 170. When executed, software instructions stored in the memory 130 and/or the storage component 140 may cause the processor 120 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 1 are provided as an example. In practice, the device 100 may include additional components, fewer components, different components, or differently arranged components than those shown in FIG. 1. Additionally, or alternatively, a set of components (e.g. one or more components) of the device 100 may perform one or more functions described as being performed by another set of components of the device 100.

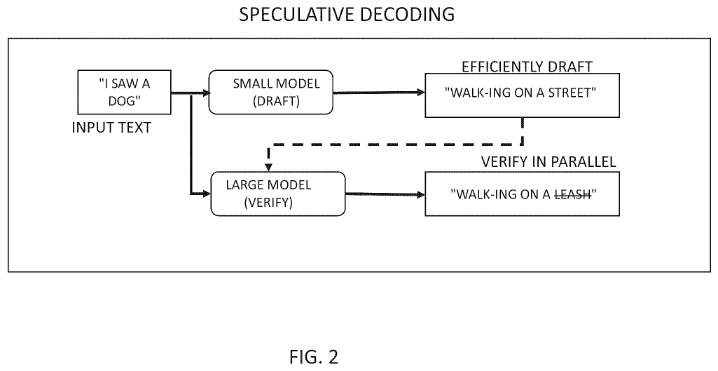

FIG. 2 illustrates an example of speculative decoding, according to an embodiment. According to an embodiment, speculative decoding leverages a small draft model to anticipate a large model and queries the large model for batch verification. The batch size depends on the targeted number of token positions in the future, for draft prediction, and the number of top-k samples at each position. The speedup is achieved via batched verification in the large model, which is much faster than autoregressive prediction in the large model.

According to an embodiment, in an early exit model, the model only uses the first N layers to process the data. In one or more embodiments, the early exit model is the small model for a speculative decoding approach, with the large model being used for batch verification. As illustrated in FIG. 2, the small model may predict that the input text will be “I saw a dog walking on a street.” However, using the large model for verification identifies that the actual input text may be “I saw a dog walking on a leash.” The verification is performed in parallel syllable-by-syllable to improve the accuracy while also improving the speed of the small model approach. In related art approaches, additional parameters may be required, which is difficult in providing on-device applications. In one or more embodiments, a classifier is used to train how many layers are necessary to process the input data.

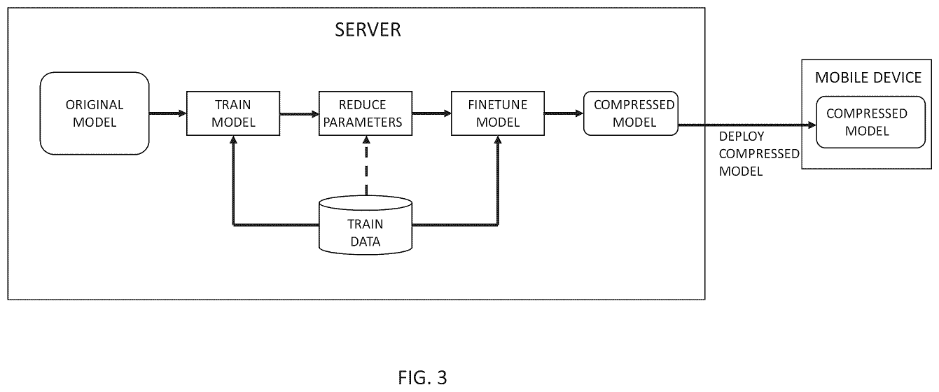

FIG. 3 illustrates an example of compressing a neural network model, according to an embodiment. According to an embodiment, compressing a neural network model may include training a neural network model using training data and corresponding labels, reducing parameters, and finetuning the neural network model to arrive at a compressed neural network model. The compressing of the neural network model may be performed on a server. However, embodiments are not limited to this. For example, the compressing of the neural network model may be performed on an electronic device, mobile device, etc.

According to an embodiment, reducing parameters may include selecting model parameters to compress or remove. According to one or more embodiments, training data may be used to determine which parameters should be removed or compressed. The compressed model may be finetuned by repeating the training of the neural network using training data and corresponding labels. The compressed neural network model may be deployed to another device, such as a mobile device.

According to one or more embodiments, the finetuning of the model improves the speed of the processing the neural network model.

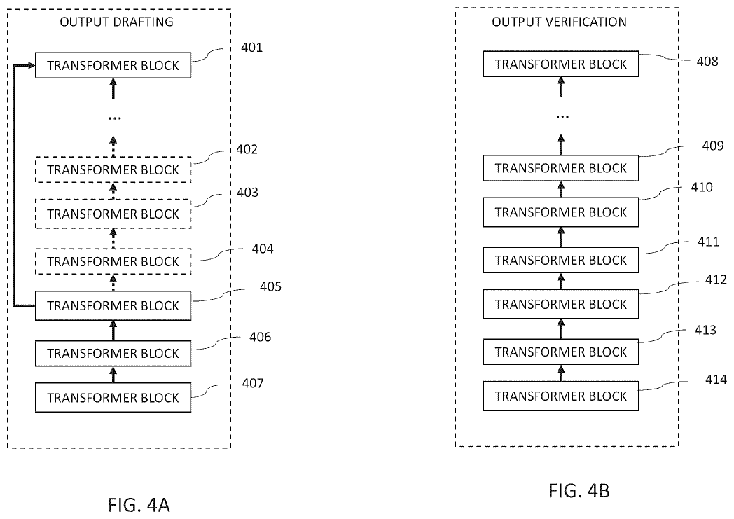

FIGS. 4A and 4B illustrate examples of output drafting and output verification, according to an embodiment. FIG. 4A illustrates an example of an output drafting process. FIG. 4B illustrates an example of an output verification process. Transformer blocks 401 to 414 (e.g., transformer layers) represent components of LLMs that process input data (e.g., text) in a way that captures relationships between words and phrases. One or more embodiments provide for speeding up output token generation throughput with a speculative decoding approach utilizing rapid output drafting combined with draft verification that is performed in parallel.

According to an embodiment illustrated in FIG. 4A, the output drafting leverages a principled metric to determine layers in the model to skip (e.g. layers 402, 403, 404 identified by the dashed boxes in FIG. 4A). Thus, a number of computations are reduced which speeds up output generation. As illustrated in FIG. 4B, during output verification, transformer block layers 409, 410, and 411 are not skipped. Thus, during output verification, the full main model is used to verify the draft tokens in parallel.

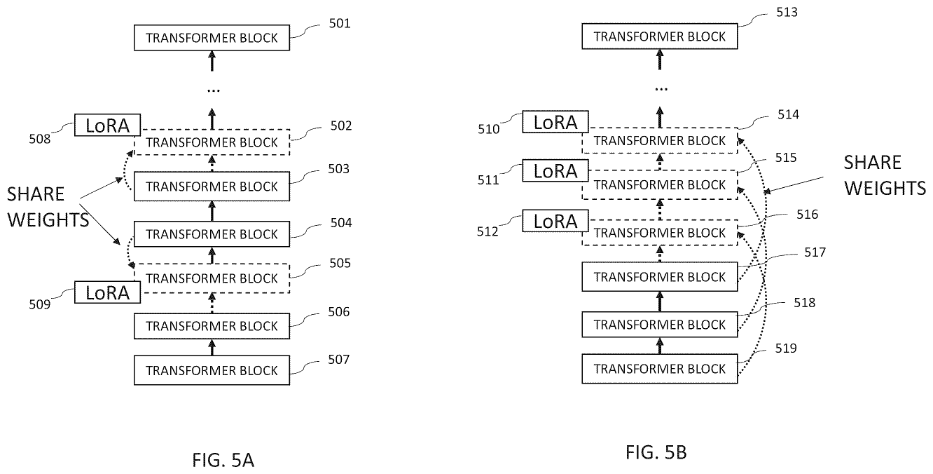

FIGS. 5A and 5B illustrate pruning and extending, according to one or more embodiments. As illustrated in FIG. 5A, the model includes transformer blocks 501 to 507. According to an embodiment, pruning a neural network model may be applied to reduce the parameters of the neural network model to create a compressed model. A pruning process may use an importance metric to identify which blocks to prune. In FIG. 5A, the dashed boxes around transformer blocks 502 and 505 indicate that those blocks have been identified for pruning. According to an embodiment, each pruned block is replaced using a weight-sharing mechanism that uses unpruned counterparts from the model and block-specific low-rank adapters (e.g., LoRA 508 to 512). For example, as illustrated in FIG. 5A, transformer block 505 uses the same weight as transformer block 504 (e.g., shared weights as indicated by dashed arrows in FIGS. 5A and 5B) and transformer block 502 uses the same weight as transformer block 503.

According to an embodiment, the learning of the replacement blocks is achieved using output feature normalization and an adapter initialization scheme built on low-rank Singular Value Decomposition (SVD) reconstructions.

There is a relationship between LoRA and the Singular Value Decomposition (SVD) of a matrix, which may be used to compress neural network models. Weight updates (e.g., ΔW) may be parameterized using LoRA parameters, which decomposes weight matrices into low-rank residuals identified by the following equation (1):

$$Δ W = AB \qquad ( 1 )$$

In the above equation, A∈ [symbol] ^{D}_{1×r}, B∈ [symbol] ^{r×D}₂,

ΔW∈ [symbol] ^{D}₁^{×D}₂, and r is a hyper-parameter controlling the rank of the weight matrix update.

The SVD of a matrix W∈ [symbol] ^{m×n} is, W=UΣV^{T}, where U∈ [symbol] ^{m×m} are orthogonal matrices and Σ∈ [symbol] ^{m×n} is a diagonal matrix of singular values. SVD is used to obtain a low-rank representation of W by selecting the k most significant singular values and their corresponding singular vectors, where k<min (m, n). Thus, the low-rank representation of W is given as:

$${W}_{k} = {U}_{k} {Σ}_{k} {V}_{k}^{T} ,$$

where Uₖ∈ [symbol] ^{m×k}, Σₖ∈ [symbol] ^{k×k}, and Vₖ∈ [symbol] ^{n×k}, have lower dimensions than U, Σ, V, respectively

As illustrated in FIG. 5B, the model includes transformer blocks 513 to 519. The neural network model may be extended to increase the performance of the neural network model with minimal additional parameters to create an expanded compressed model. According to an embodiment for extending models, block patterns are repeated (e.g., dashed transformer blocks 514, 515, 516) using the weight-sharing mechanism as described above, block-specific low-rank adapters, and output feature normalization.

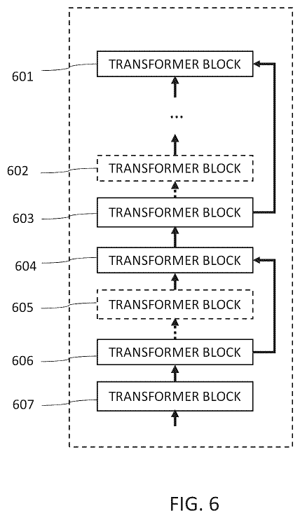

FIG. 6 illustrates an example of skipping model blocks, according to an embodiment. As illustrated in FIG. 6, the model includes transformer blocks 601 to 607. The transformer blocks 602 and 605 may be skipped to speed up the process during the output drafting process. The blocks to skip during output drafting are selected using a fixed criterion that determines which block will least degrade the model after being removed. According to an embodiment, the skipped block may be selected by using a block influence (BI) score, which identifies the extent to which each block transforms its input, with higher scores indicating more significant changes.

According to one or more embodiments, the BI score is identified for every block in the large model using a sample of training data the model was trained on, and then the process skips a pre-defined number of blocks with the lowest scores during the output drafting stage. This increases the speed of token generation. Then, the main model is used in its entirety (e.g., without skipping blocks) to verify these tokens in parallel after every M (predetermined number) draft tokens. Thus, the accuracy of the main model is retained. The BI score may be determined by the following equation (2):

$${BI}_{i} = 1 - {𝔼}_{X , t} \frac{{X}_{i , t}^{T} {X}_{i + 1 , t}}{{‖ {X}_{i , t} ‖}_{2} {‖ {X}_{i + 1 , t} ‖}_{2}} \qquad ( 2 )$$

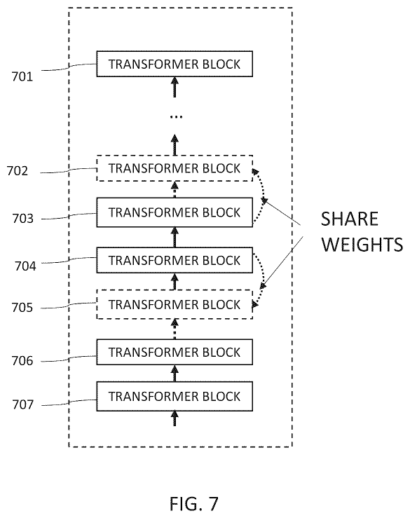

FIG. 7 illustrates an example of selecting replacement blocks, according to an embodiment. As illustrated in FIG. 7, the model includes transformer blocks 701 to 707. The features illustrated in FIG. 7 may be applied to large models which use parameter efficiency via pruning in addition to speeding output token generation.

Equation (2) above may be determined for every transformer block in the large model (e.g., main model) using a sample of training data the model is trained on. According to an embodiment, a pre-defined number of blocks with the lowest scores are pruned (e.g., removed). Thus, a compressed model is created with fewer parameters than the large model.

According to one or more embodiments, it is possible to recover post-prune performance (i.e., post-compression performance), by using weight-sharing within the neural network. That is, the pruned blocks may be replaced with the remaining blocks from the large model.

Block weights may be used more than once in the model. The block weights may continue to be used in their original position, but may be repeated in place of one or more pruned blocks. According to an embodiment, the unpruned blocks in the model are selected based on being similar to the pruned blocks.

One or more embodiments use a metric based on low-rank SVD reconstructions to match a similarity between pruned blocks (referred to as Wᵢ) and candidate replacement blocks (referred to as Wⱼ). The distance metric d (Wᵢ, Wⱼ) for selecting a replacement block is defined by the following equation (3):

$$d ( {W}_{i} , {W}_{j} ) = {‖ {\hat{W}}_{i} - ( {\hat{W}}_{j} + {Δ}_{i - j} ) ‖}_{F} , \qquad ( 3 )$$

where Ŵᵢ and Ŵⱼ are low-rank SVD reconstructions of Wᵢ and Wⱼ, respectively, using the first r ranks. Δᵢ₋ⱼ [symbol] (Uᵢ₋ⱼΣᵢ₋ⱼ)[1:r](Vᵢ₋ⱼ[1:r])^{T} is the rank−r approximation of a difference Ŵᵢ−Ŵⱼ. ∥⋅∥F denotes the Frobenius norm. The low-rank approximations Ŵᵢ and Ŵⱼ are obtained by the following equations:

$${\hat{W}}_{i} = ( {U}_{i} {Σ}_{i} ) [ 1 : r ] {( {V}_{i} [ 1 : r ] )}^{T} \qquad ( 4 )$$

$${\hat{W}}_{j} = ( {U}_{j} {Σ}_{j} ) [ 1 : r ] {( {V}_{j} [ 1 : r ] )}^{T} \qquad ( 5 )$$

According to an embodiment, for each pruned block i, its base is selected for weight sharing as the candidate block j with the minimum score in equation (3) in which:

$$j = {arg min}_{{j}^{′} \neq i} d ( Wi , {Wj}^{′} ) \qquad ( 6 )$$

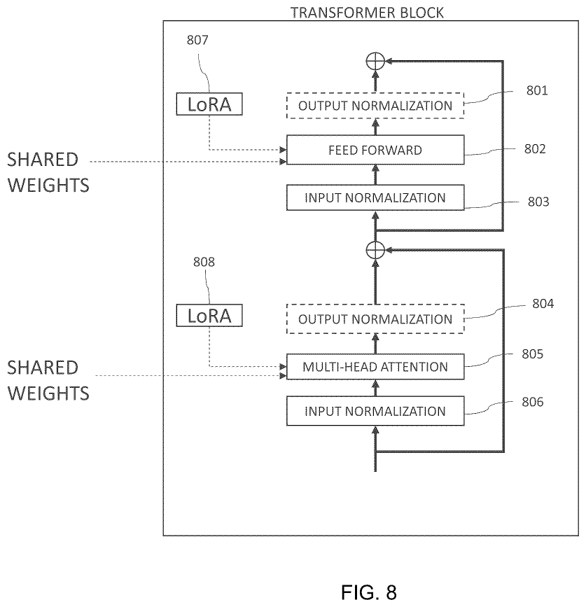

FIG. 8 illustrates an example of normalizing features for a transformer block, according to an embodiment. A new architecture block is provided to replace the pruned blocks from the model.

According to one or more embodiments, the new architecture block may include shared weights from another unpruned block, output normalization (e.g., 801 and 804), and low-rank adapters (LoRA) (e.g., 807 and 808) that are unique to each weight in the block. The input normalization 803 and 806 occurs by initializing to a small value set by a hyperparameter, allowing the model to learn and adjust output magnitudes over time.

The shared weights from another unpruned block in the model are represented by equation (6) above. The output normalization in operations 801 and 804 are represented by the following equation (7):

$${h}_{norm} = \frac{h - μ ( h )}{σ ( h )} \times γ , \qquad ( 7 )$$

where h is the output of the layer before normalization, μ(h) is the mean of h, σ(h) is the standard deviation of h, and γ is a learnable scaling weight of the same dimension as the model hidden state size.

The difference between the pruned block Wi and the replacement block Wj is decomposed into low-rank matrices represented by equation (8) below:

$${W}_{i} - {W}_{j} = {U}_{i - j} {Σ}_{i - j} {V}_{i - j}^{T} \qquad ( 8 )$$

The low-rank adapters (LoRA) 807 and 808 are unique to each weight in the transformer block. The LoRA adapters are initialized as the low-rank SVD difference between the pruned blocks (Wᵢ) and replacement block (Wⱼ) as given in equation (9) below in which adapter matrices A and B are initialized as:

$$A = ( {U}_{i - j} {Σ}_{i - j} ) [ 1 : r ] , B = {( {V}_{i - j} [ 1 : r ] )}^{T} , \qquad ( 9 )$$

where (Uᵢ₋ⱼΣᵢ₋ⱼ)[1:r] is the product of the left singular vectors and the diagonal matrix of singular values, indexed to take the first r columns; and (Vᵢ₋ⱼ[1:r])^{T} is the transposed matrix containing the first r columns of the right singular vectors.

According to an embodiment, only large weights are shared, and the new architecture block creates its own copies of smaller weights. For the transformer architecture, the normalization weights may be unique to each block, and the multi-head attention 805 and feed forward weights 802 may be shared. The new architecture is trained using neural network optimization practices and training data until convergence. During generation, the model may draft tokens using the pruned model (e.g., faster, less accurate), and verify tokens using the main model (e.g., slower, more accurate). Thus, one or more embodiments produce a compressed model with higher throughput and fewer stored parameters.

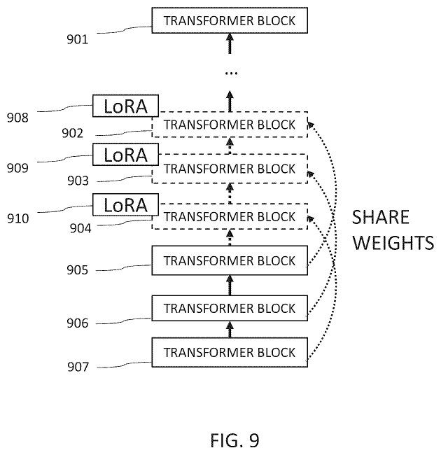

FIG. 9 is an example of extending a neural network model by repeating transformer blocks, according to an embodiment. The model may include transformer blocks 901 to 907. According to an embodiment illustrated in FIG. 9, blocks 905, 906, and 907 may be repeated as blocks 902, 903, and 904, respectively, of an unpruned model in a sequence. Each repeated block 902, 903, 904, has unique LoRA adapters 908, 909, 910, respectively, and normalization parameters, and output normalization is applied to repeated blocks after the first repetition.

According to an embodiment, two repetition patterns may be used: (1) block repetition, in which each block is repeated a specified number of times; or (2) sequential repetition, in which an entire sequence of blocks is repeated in a specified manner.

According to an embodiment, the extended compressed model may be trained using neural network optimization practices and training data until convergence. During generation, the model may draft tokens using the main model (e.g., faster, less accurate), and verify tokens using the extended model (e.g., slower, more accurate). The result is an extended compressed model which retains throughput and parameter efficiency similar to the main model, but with higher accuracy.

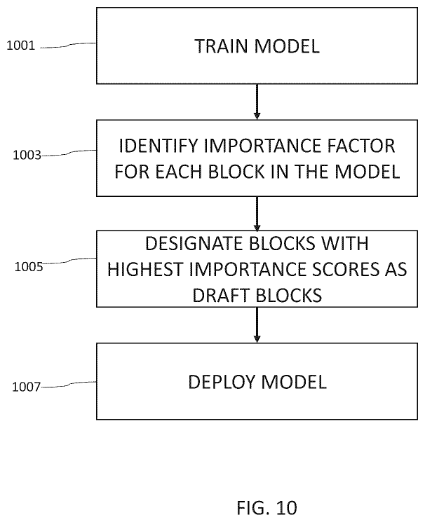

FIG. 10 is an example method of generating a neural network model, according to an embodiment. In operation 1001, method may include training the model on a server device. The model may be trained using training data and corresponding labels.

In operation 1003, the method includes calculating or identifying an importance factor (e.g., BI score) for each transformer block in the model. For example, a BI may be identified for each transformer block using equation (2) above. The BI score may be identified for every block in the large model using a sample of training data the model was trained on.

In operation, 1005, the method includes designating transformer blocks with the highest importance as draft blocks. In operation 1007, the method includes deploying the model. The model may be deployed to a mobile device and/or a server device.

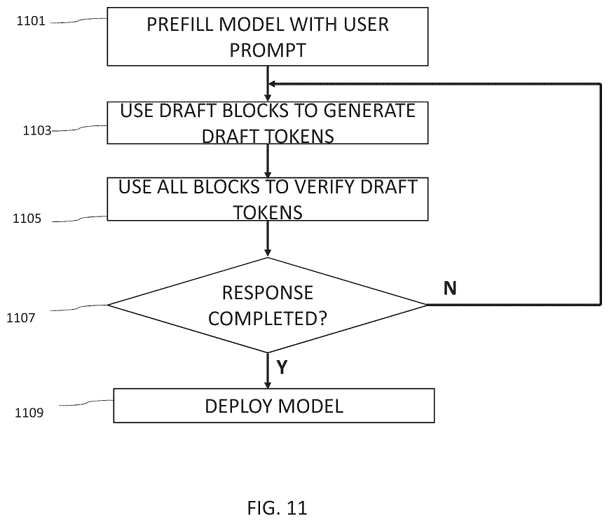

FIG. 11 is an example method of deploying a language model on a mobile device, according to an embodiment. The mobile device may be a mobile phone, a smartphone, and/or a smart tablet. In operation 1101, the method may include prefilling the model with a user prompt. The user prompt may be a voice input that is converted using automatic speech recognition (ASR) to convert a user's voice to text. Additionally, a user may configure the generation speed of the language model by user input. Higher speed will result in reduced generation quality. Lower speed will result in better generation quality.

In operation 1103, the method may include using draft blocks to generate draft tokens. The method may include skipping a pre-defined number of blocks with the lowest importance scores during the output drafting stage, which increases the speed of token generation. In operation 1105, the method may include using all blocks to verify the draft tokens. Then, the main model is used in its entirety (e.g., without skipping blocks) to verify these tokens in parallel after every M (predetermined number) draft tokens. Thus, the accuracy of the main model is retained. In operation 1107, it is determined if the response identified by the user prompt is completed. If the response is not completed, operations 1103 and 1105 are performed repeatedly, until the response is completed. If the response is completed, the method may include deploying the model in operation 1109. The model may be deployed to a mobile device and/or a server device.

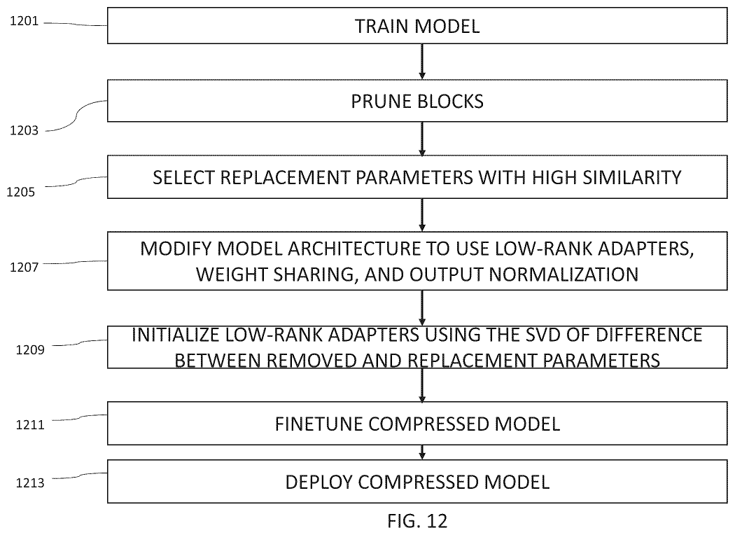

FIG. 12 is an example method of generating a neural network model, according to an embodiment. In operation 1201, the method may include training a model on a server device. The model may be trained using training data and corresponding labels.

In operation 1203, the method may include pruning blocks. For example, as described above with respect to FIG. 5A, the pruning a neural network model may be applied to reduce the parameters of the neural network model to create a compressed model. A pruning process may use an importance metric to identify which blocks to prune.

In operation 1205, the method may include selecting replacement parameters with high similarity to the removed parameters, as identified by equation (6) above.

In operation 1207, the method may include modifying model architecture to use low-rank adapters, weight sharing, and output normalization. In operation 1209, the method may include initializing low-rank adapters using the SVD of the difference between removed and replacement parameters, as identified in equation (9) above. In operation 1211, the compressed model may be finetuned to reduce compression performance loss by repeatedly training the model using training data and corresponding labels. In operation 1213, the method may include deploying the compressed model.

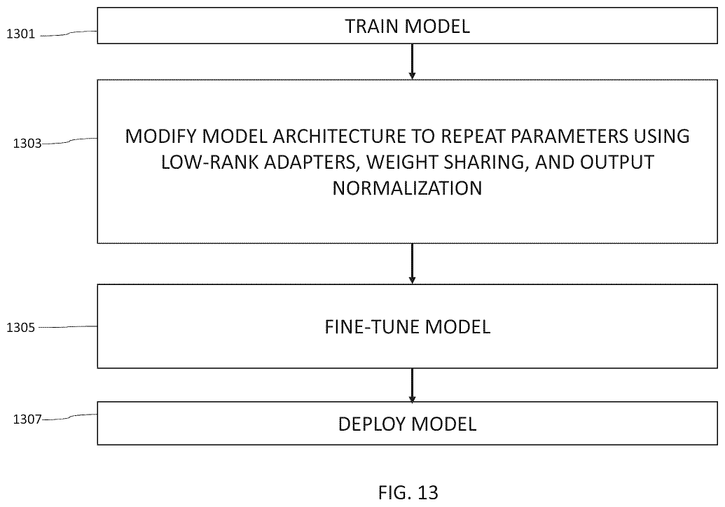

FIG. 13 is an example method of generating a neural network model, according to an embodiment. In operation 1301, the method may include training the model. The model may be trained on a server device using training data and corresponding labels. In operation 1303, the method may include modifying the model architecture to repeat parameters using LoRA, weight sharing, and output normalization. In operation 1305, the method may include fine-tuning the model to reduce compression performance loss by repeatedly training the model using training data and corresponding labels. In operation 1307, the method may include deploying the model on a mobile device or on a server device.

While the one or more embodiments of the disclosure have been described with reference to the figures, it will be understood by those of ordinary skill in the art that various changes in form and details may be made therein without departing from the spirit and scope as defined by the following claims.

What is claimed is:

1. A method of generating a token for a language model, the method comprising:
obtaining a language model comprising one or more transformer blocks;
training the language model based on one or more parameters;
identifying a first parameter, from among the one or more parameters, to compress or remove from the language model;
finetuning the language model based on the first parameter being compressed or removed; and
providing the finetuned language model to an electronic device.

2. The method of claim 1, wherein the identifying the first parameter to compress or remove comprises identifying a block to remove based on a degree of degradation caused by removing the block.

3. The method of claim 2, wherein the identifying the block to remove based on the degree of degradation comprises generating an influence score.

4. The method of claim 1, further comprising performing verification of the language model in parallel with performing drafting of the language model.

5. The method of claim 1, further comprising pruning the language model to reduce the one or more parameters.

6. The method of claim 5, wherein the pruning the language model comprises using a weight-sharing mechanism.

7. The method of claim 1, further comprising extending the language model to increase accuracy of the language model.

8. A server device comprising:
a memory storing instructions; and
at least one processor,
wherein the instructions, when executed by the at least one processor, cause the server device to:
obtain a language model comprising one or more transformer blocks;
train the language model based on one or more parameters;
identify a first parameter, from among the one or more parameters, to compress or remove from the language model;
finetune the language model based on the first parameter being compressed or removed; and
provide the finetuned language model to an electronic device.

9. The server device of claim 8, wherein the instructions, when executed by the at least one processor, cause the server device to identify a block to remove based on a degree of degradation caused by removing the block.

10. The server device of claim 9, wherein the instructions, when executed by the at least one processor, cause the server device to identify the block to remove based on the degree of degradation by generating an influence score.

11. The server device of claim 8, wherein the instructions, when executed by the at least one processor, cause the server device to perform verification of the language model in parallel with performing drafting of the language model.

12. The server device of claim 8, wherein the instructions, when executed by the at least one processor, cause the server device to prune the language model to reduce the one or more parameters.

13. The server device of claim 12, wherein the instructions, when executed by the at least one processor, cause the server device to prune the language model by using a weight-sharing mechanism.

14. The server device of claim 8, wherein the instructions, when executed by the at least one processor, cause the server device to extend the language model to increase accuracy of the language model.

15. A non-transitory computer-readable recording medium configured to store instructions for generating a language model, which, when executed by at least one processor of an electronic device, cause the at least one processor to perform a method comprising:
obtaining a language model comprising one or more transformer blocks;
training the language model based on one or more parameters;
identifying a first parameter, from among the one or more parameters, to compress or remove from the language model;
finetuning the language model based on the first parameter being compressed or removed; and
providing the finetuned language model to another electronic device.

16. The non-transitory computer-readable recording medium of claim 15, wherein the identifying the first parameter to compress or remove comprises identifying a block to remove based on a degree of degradation caused by removing the block.

17. The non-transitory computer-readable recording medium of claim 16, wherein the identifying the block to remove based on the degree of degradation comprises generating an influence score.

18. The non-transitory computer-readable recording medium of claim 15, wherein the instructions, when executed by the at least one processor, cause the at least one processor to perform the method comprising performing verification of the language model in parallel with performing drafting of the language model.

19. The non-transitory computer-readable recording medium of claim 15, wherein the instructions, when executed by the at least one processor, cause the at least one processor to perform the method comprising pruning the language model to reduce the one or more parameters.

20. The non-transitory computer-readable recording medium of claim 19, wherein the pruning the language model comprises using a weight-sharing mechanism.
